(19) United States
(12) Patent Application Publication
(10) Pub. No.: US 2006/0181415 A1
(43) Pub. Date: Aug. 17, 2006

(54) Diver proximity monitoring system and method

(76) Inventor: Taeyoung Park, San Jose, CA (US)

Correspondence Address: TAEYOUNG PARK, 3379 ROYAL MEADOW LANE, SAN JOSE, CA, 95135, US

(21) Appl. No.: 11/047,803

(22) Filed: Feb. 1, 2005

(51) Int. Cl. G08B 1/08; G01S 13/08; G01S 5/14; G08B 23/00; G08B 21/00

(52) U.S. Cl. 340/539.23; 340/573.1; 340/686.6; 342/125; 342/357.08

(57) ABSTRACT

A proximity monitoring system and method for use by scuba divers that includes at least a first transmitting unit worn or otherwise attached to or held by a first scuba diver and a s second monitoring unit worn or otherwise attached to or held by a second scuba diver. The monitoring system and method serve to monitor the proximity of the second scuba diver to the first transmitting unit and provides an alarm that warns the first scuba diver and the second scuba diver that they have moved beyond a preset distance from one another.

### BACKGROUND OF THE INVENTION

The present invention generally relates to signaling systems and methods for scuba divers. More specifically, this invention relates to a proximity monitoring system and method that provides an alert when a first scuba diver has moved beyond a preset distance from a second scuba diver.

For safety reasons, it is important that a scuba diver remain in close proximity to a second scuba diver or dive buddy when diving. The scuba diver and his dive buddy need to be able to assist one another if an emergency situation arises. It is particularly important underwater where response time is critical for safety. It is therefore imperative that the diver and his dive buddy stay within close proximity to one another. However the scuba diver is often distracted by sights or can be affected by the environment, such as low visibility, and can end up at an unsafe distance from his dive buddy. It requires both divers to constantly monitor the proximity of each other and signal the other diver if he is too far away.

There are several mechanical devices and methods available today to keep the scuba diver close to his dive buddy. A rope or lanyard is often used under low visibility conditions to attach the divers together. Although effective in keeping a diver or group of divers together, the mechanical systems have limitations. The rope, for example, often gets entangled posing a danger to the divers. Also mechanical restraint systems do not allow individual divers the freedom to explore safely.

Beacon systems where a transmit signal is periodically sent is also discussed in the prior art. These systems are used to locate a boat or a central location. Once the scuba diver wishes to return he activates his receiver unit to locate the beacon. Although somewhat effective in keeping divers within an area or prevent them from getting lost, these types of systems do not prevent the scuba diver from separating from his dive buddy.

There are also several devices and methods available today to signal another diver. For example, some mechanical or electronic means to locally generate a sound that is intended to be heard by the dive buddy is discussed in the prior art. Although somewhat effective in getting the attention of the dive buddy, they do nothing to alert the divers that they are too far apart from one another. By the time the divers realize that they are not in close proximity to one another they may be too far from each other to do much good in an emergency.

There are also underwater signaling systems and methods available such as underwater communicators and paging systems used not only for communications but for emergency signaling as well. These systems rely on a signal with a message being received by an intended diver with a similar device. However, because of the underwater environment, signal reception is not reliable. Obstructions, water salinity, rocks etc. often interfere with signal integrity. In an emergency situation the signal might not get through to the other diver and even if it did the divers might be too far apart to make any difference. In addition, these systems also require the diver to activate a switch to generate the signal. In an emergency this might not be possible for the scuba diver in distress.

As can be determined, previous systems and methods do not address the need to monitor the proximity of the scuba diver to his dive buddy, alert the diver and his dive buddy that they are not in close proximity to one another and prevent an unsafe situation where the scuba diver and his dive buddy are at an unsafe distance from one another. One of the best safety practices when scuba diving is having your dive buddy remain at close proximity to be of effective assistance in emergency situations.

### SUMMARY OF THE INVENTION

The present invention is embodied in a system and method for monitoring the proximity of a scuba diver and another scuba diver or scuba divers to one another and alerting them when they are no longer within a preset safe distance from one another. The system and method include at least a first transmitting unit worn or otherwise attached to or held by a first scuba diver and at least a second monitoring unit worn or otherwise attached to or held by a second scuba diver.

The first transmitting unit includes a means for transmitting a monitoring signal and a means for initiating said means for transmitting. The second monitoring unit has a means for receiving said monitoring signal and a means for reinitializing an alarm timer when said monitoring signal is received by said means for receiving. Finally the second monitoring unit includes an alarm that is activated by the expiration of the alarm timer.

With the present invention a diver and his dive buddy or buddies can swim anywhere within a preset distance of each other whose radius is established by the distance designated by the first transmitting unit and the second monitoring unit or units. The alarm on the second monitoring unit or units will activate when the monitoring signal from the first transmitting unit is interrupted, i.e. when the second monitoring unit or units have moved outside the range of the first transmitting unit, and the alarm timer fails to be reinitialized.

From the above it can be appreciated that this invention provides an immediate warning to the scuba diver and his dive buddy that they are not within close proximity of one another. This invention will allow the scuba diver to enjoy the diving experience with the knowledge that their dive buddy is close by, and that they have the means to ensure that their dive buddy remains in close proximity providing an additional layer of safety.

### BRIEF DESCRIPTION OF THE DRAWINGS

The present invention will now be described, by way of example, with reference to the accompanying drawings, in which:

FIG. 1 is an illustration of a first transmitting unit that can be worn or otherwise attached to or held by the first diver.

FIG. 2 is an illustration of a second monitoring unit that can be worn or otherwise attached to or held by the second diver.

FIG. 3 is a functional block diagram of the first transmitting unit designed in accordance with the principles of this invention.

FIG. 4 is a flow chart illustrating the operational process of the first transmitting unit shown in FIG. 3.

FIG. 5 is a functional block diagram of the second monitoring unit designed in accordance with the principles of this invention.

FIG. 6 is a flow chart illustrating the operational process of the second monitoring unit shown in FIG. 5.

### DETAILED DESCRIPTION OF THE PREFERRED EMBODIMENT

A diver proximity monitoring system and method for use by divers to monitor the proximity of at least one diver to a second diver and alert the divers that they are no longer in close proximity to one another is herein described.

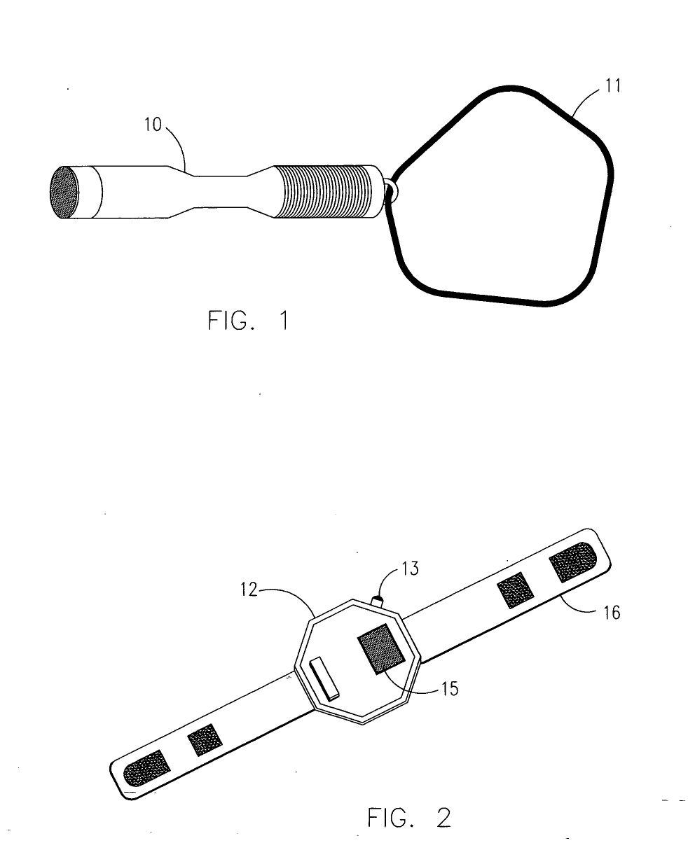

The diver proximity monitoring system and method include at least a first transmitting unit worn or otherwise attached to or held by a first diver and a second monitoring unit worn or otherwise attached to or held by a second diver. FIG. 1 illustrates a hand held unit (10) in accordance with this invention. The hand held unit (10) includes a lanyard (11) to prevent the hand held unit (10) from dropping accidentally. FIG. 2 illustrates a wrist worn unit (12) in accordance with this invention. The unit has an on-off switch (13), an alarm (15), and a Velcro strap (16). Other enclosure types would also be suitable. In one design form, an enclosure, for the first transmitting unit and\or the second monitoring unit could be magnetically attached to the air tank or be a necklace worn around the neck. In another design form the diver proximity system and method could be integrated into other scuba equipment such as a scuba dive computer. In yet another design form the first transmitting unit and the second monitoring unit could be contained in one enclosure forming one unit. Suitable materials and construction methods for this purpose are within the capability of those skilled in the art, and will not be discussed in great detail. It is generally sufficient to say that the first transmitting unit and second monitoring unit are preferably enclosed in a watertight enclosure that resists the operating environment.

The diver proximity monitoring system and method utilize wireless communication between the first transmitting unit and the second monitoring unit. The system and method has a means for transmitting (25) a monitoring signal and a means for receiving (35) said monitoring signal. In one design form, said monitoring signal is an on-off signal pulse of preset duration. Said on-off signal pulse can comprise of a single signal pulse or a series of signal pulses representing a unique identification code. In one design form said diver proximity monitoring system and method also has a means to adjust the output power of said means for transmitting (25) and/or adjust the sensitivity of said means for receiving (35). This would, in effect, allow the divers to vary the distance away from one another that they want to be alerted. Under low visibility the scuba diver and his dive buddy may want to remain in very close proximity, and be alerted when they are closer together. In relatively calm clear waters the scuba divers may want a wider distance between each other while remaining in safe proximity, and be alerted when they are further apart from each other.

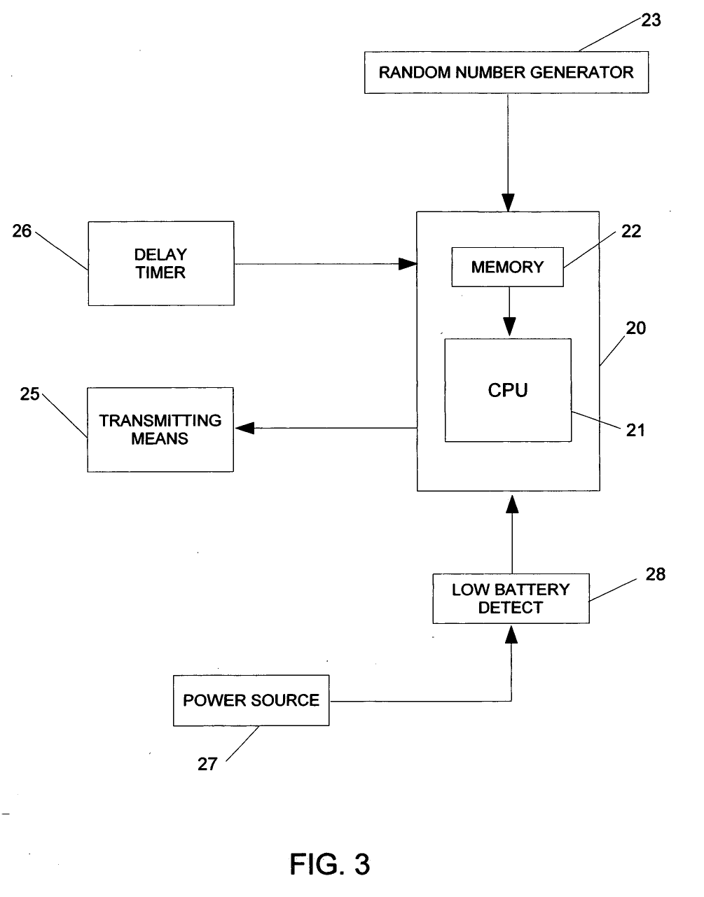

The first transmitting unit, in accordance with this invention, is represented by the functional block diagram in FIG. 3. It includes a microcontroller (20) that incorporates a CPU (21) and memory (22). The memory (22) may include read-only memory, random access memory, non-volatile memory or a combination thereof. The first transmitting unit also includes a means for transmitting (25) said monitoring signal. Said means for transmitting (25) can be sound, ultrasound, magnetic induction, radio frequency, optical or other such wireless means as known by those skilled in the art.

Further, the first transmitting unit includes a means for initiating said means for transmitting (25). In one embodiment, said means for initiating said means for transmitting (25) is the expiration of a periodic timer which reinitializes with a predetermined value at the end of transmission of said monitoring signal. In another embodiment, said means for initiating is the expiration of a delay timer (26) whose delay time is reinitialized with a random value generated by a random number generator (23) at the end of transmission of said monitoring signal by said means for transmitting (25). This will ensure that said monitoring signal does not permanently collide and interfere with other monitoring signals in a specific dive area. It can be appreciated by those skilled in the arts that the periodic timer, the delay timer (26), and\or the random number generator (23) could be implemented by the CPU (21) in software or be part of the microcontroller (20) functionality.

Finally, the first transmitting unit includes a power source (27) to provide power to all the functional elements previously described. In one design form, the power source (27) would be monitored by a low battery detect circuit (28). When triggered, the CPU (21) would initiate a low battery warning.

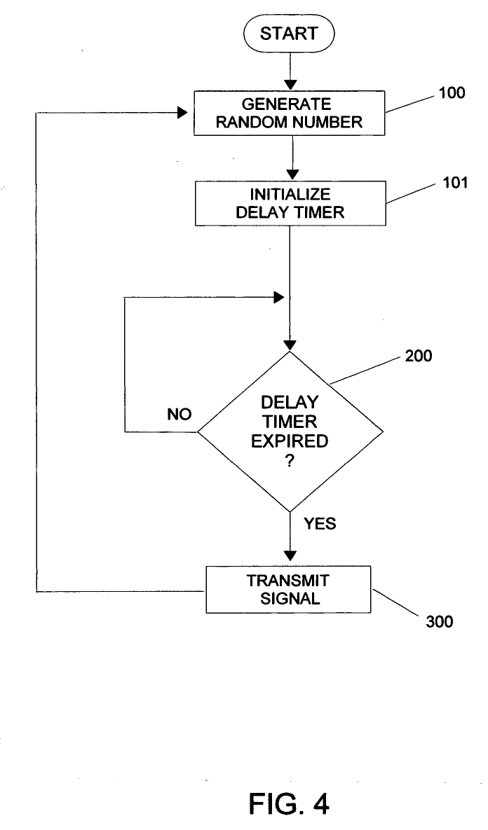

A flowchart of the operational process of the first transmitting unit is illustrated in FIG. 4. At the start (100), the random number generator (23) generates a random value.

In step (101) the CPU (21) initializes the delay timer (26) with said random value and starts the delay timer (26). In step (200), the CPU (21) determines whether the delay timer (26) has expired. If the result of the determination in step (200) is NO, the CPU (21) waits. In one design form, the CPU (21), while waiting could put itself into a sleep mode in order to conserve power. If the result of the determination in step (200) is YES, the CPU (21) in step (300) transmits said monitoring signal by said means of transmitting (25). After step (300), the operational process returns to step (100) where the cycle is repeated.

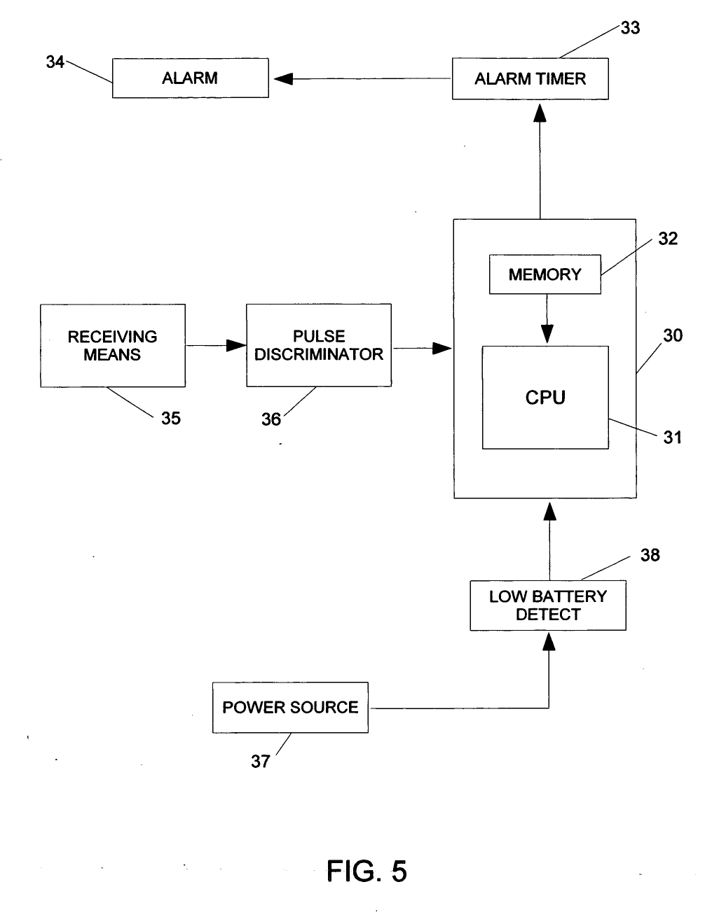

The second monitoring unit in accordance with this invention is represented by the functional block diagram in FIG. 5. It includes a microcontroller (30) that incorporates a CPU (31) and memory (32). The memory (32) may include read-only memory, random access memory, non-volatile memory or a combination thereof. The 15 second monitoring unit also includes a means for receiving (35) said monitoring signal. Said means for receiving (35) can be sound, ultrasound, magnetic induction, radio frequency, optical or other such wireless means as known by those skilled in the art.

Further, the second monitoring unit includes an alarm timer (33). The alarm timer (33) is reinitialized with a predetermined alarm timer value by the CPU (30) when said 20 monitoring signal is received by said means for receiving (35). If the CPU (30) fails to reinitialize the alarm timer (33) i.e. the alarm timer (33) expires, an alarm (34) is activated. In one embodiment, the alarm (34) is an audible alarm. In another embodiment the alarm (34) is a visual alarm. In yet another embodiment, the alarm (34) is a vibration alarm.

Finally, the second monitoring unit includes a power source (37) to provide power to all the functional elements previously described. In one design form, the power source (37) would be monitored by a low battery detect circuit (38). When triggered, the CPU (31) would initiate a low battery warning.

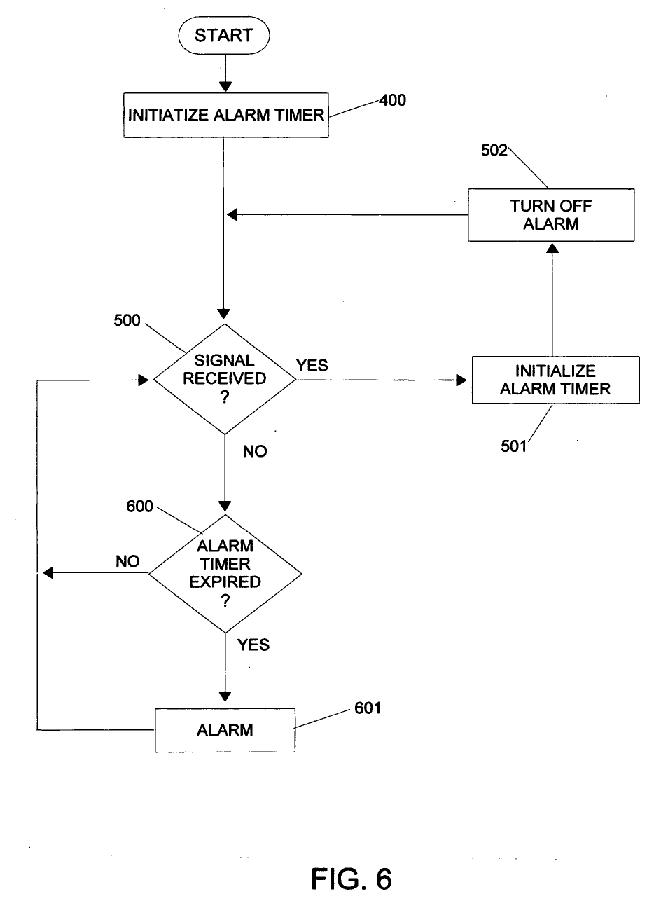

A flowchart of the operational process of the second monitoring unit is illustrated 30 in FIG. 6. At the start (400), the alarm timer (33) is initialized with the predetermined alarm timer value and started by the CPU (31). In step (500), the CPU (31) determines whether said monitoring signal has been received by said means for receiving (35). In one embodiment, the determination whether said monitoring signal has been received is made by a pulse discriminator (36) which rejects monitoring signals that are too short and\or too long in duration. In another embodiment, the determination whether said monitoring signal has been received requires that said monitoring signal have a unique identification code that matches an internal identification code. If the result of the determination in step (500) is YES, the alarm timer (33), in step (501), is reinitialized with the predetermined alarm timer value and restarted by the CPU (31). This will in effect prevent the alarm timer (33) from expiring and activating the alarm (34). The CPU (31) in step (502) turns off the alarm (34) if the alarm (34) is active due to a previous expiration of the alarm timer (33). In other words, step (502) automatically turns off the alarm (34) when the diver and his dive buddy are once again within proximity of each other. The operational process returns to step (500) where the cycle is repeated. If the result of the determination in step (500) is NO, the operational process proceeds to step (600).

In step (600), the CPU (21) determines if the alarm timer (33) has expired. If the result of the determination is YES, the alarm (34) in step (601) is activated and the operational process returns to step (500) where the cycle is repeated. If the result of the determination in step (600) is NO, the operational process immediately returns to step (500) where the cycle is repeated.

What is claimed is:

1. A system for monitoring the proximity of at least one diver to a second diver and providing an alarm when the scuba divers are beyond a preset distance from one another, comprising: a first transmitting unit comprising:
means for transmitting a monitoring signal;
means for initiating a transmission of said monitoring signal by said means for transmitting; and
a second monitoring unit that is worn or otherwise attached to or held by the second diver comprising:
means for receiving said monitoring signal;
an alarm timer that is reinitialized when said monitoring signal is received by said means for receiving; and
an alarm that is activated when said alarm timer fails to reinitialize because said monitoring signal is not received by said means for receiving.

2. The system as recited in claim 1, wherein said means for transmitting from the first transmitting unit and said means for receiving from the second monitoring unit form a wireless link.

3. The system as recited in claim 1, wherein said means for transmitting comprises sound, ultrasound, magnetic induction, radio frequency or optical means.

4. The system as recited in claim 1, wherein said means for receiving comprises sound, ultrasound, magnetic induction, radio frequency or optical means.

5. The system as recited in claim 1, wherein said monitoring signal transmitted by said means for transmitting is a signal pulse of predetermined duration.

6. The system as recited in claim 1, wherein the monitoring signal transmitted by said means for transmitting is a series of signal pulses representing a unique identification number that can be compared with an internal identification number contained in the second monitoring unit.

7. The system as recited in claim 1, wherein said means for initiating a transmission is the expiration of a periodic timer which reinitializes with a predetermined value at the end of said means for transmitting.

8. The system as recited in claim 1, wherein said means for initiating a transmission is the expiration of a delay timer whose delay time is reinitialized by a random value generated by a random number generator at the end of said means for transmitting.

9. The system as recited in claim 1, wherein more than one monitoring unit responds to the same monitoring signal transmitted by the first transmitting unit.

10. The system as recited in claim 1, wherein the first transmitting unit and the second monitoring unit form one unit.

11. A method for monitoring the proximity of at least one diver to a second diver and providing an alarm when the divers are beyond a preset distance from one another, comprising:
means for transmitting a monitoring signal;
means for initiating a transmission of said monitoring signal by said means for transmitting;
means for receiving said monitoring signal;
an alarm timer that is reinitialized when said monitoring signal is received by said means for receiving; and
an alarm that is activated when said alarm timer fails to reinitialize because said monitoring signal is not received by said means for receiving.

12. The method as recited in claim 11, wherein said means for transmitting from the first transmitting unit and said means for receiving from the second monitoring unit form a wireless link.

13. The method as recited in claim 1 1, wherein said means for transmitting comprises sound, ultrasound, magnetic induction, radio frequency or optical means.

14. The method as recited in claim 11, wherein said means for receiving comprises sound, ultrasound, magnetic induction, radio frequency or optical means.

15. The method as recited in claim 11, wherein said monitoring signal transmitted by said means for transmitting is a signal pulse of predetermined duration.

16. The method as recited in claim 1 1, wherein said monitoring signal transmitted by said means for transmitting is a series of signal pulses representing a unique identification number that can be compared with an internal identification number contained in the second monitoring unit.

17. The method as recited in claim 1 1, wherein said means for initiating a transmission is the expiration of a periodic timer which reinitializes with a predetermined value at the end of said means for transmitting.

18. The method as recited in claim 11, wherein said means for initiating a transmission is the expiration of a delay timer whose delay time is reinitialized by a random value generated by a random number generator at the end of said means for transmitting.

19. The method as recited in claim 11, wherein said means for initiating a transmission is the reception of the monitoring signal by said means for receiving.

20. The method as recited in claim 11, wherein more than one monitoring unit responds to the same monitoring signal transmitted by the first transmitting unit.

21. The method as recited in claim 11, wherein the first transmitting unit and the second monitoring unit form one unit.
